(19) United States
(12) Patent Application Publication
(10) Pub. No.: US 2009/0007818 A1
(43) Pub. Date: Jan. 8, 2009

(54) Silanization of Wood Turnings and Fibers for Producing Wood-Plastic Composite Materials

(75) Inventors: Holger Militz, Bovenden (DE); Carsten Mai, Goettingen (DE); Peter Jenkner, Wesel (DE); Roland Edelmann, Rheinfelden (DE); Burkhard Standke, Loerrach (DE); Peter Michel, Hof (DE); Jens-Uwe Bergmann, Rehau (DE); Steven Schmidt, Doehlau (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GMBH, ESSEN (DE)

(21) Appl. No.: 12/281,629

(22) PCT Filed: Mar. 20, 2007
(86) PCT No.: PCT/EP07/52620

§ 371 Date: Sep. 4, 2008

(30) Foreign Application Priority Data
Mar. 20, 2006 (DE) 102006 013090.1

(51) Int. Cl. C08L 97/02

(52) U.S. Cl. 106/137.6

(57) ABSTRACT

The present invention relates to composite materials composed of lignocellulosic fibers, for example wood meal, and thermoplastic polymer. The inventive composite material has improved mechanical properties. According to the invention, it is envisaged that the lignocellulosic fibers, before mixing with the thermoplastic polymer, are treated with an aqueous mixture composed of organopolysiloxanes which contain aminoalkylalkoxysilanes.

The present invention relates to composite materials comprising wood and thermoplastics, in which lignocellulosic material, such as wood in the form of particles, for example as wood flour, wood fibers or wood chips, mixed with a thermoplastic forms a composite material. Furthermore, the present invention relates to a process for producing a composite material comprising lignocellulosic material and a thermoplastic.

### PRIOR ART

U.S. Pat. No. 4,717,742 describes wood-reinforced thermoplastic composite materials of the generic type comprising wood pulp and polyethylene or isotactic polypropylene, the plastic containing in each case maleic anhydride. For improving the adhesion between lignocellulosic fibers on the one hand and plastic on the other hand, the lignocellulosic fibers are treated with γ-aminopropyltriethoxysilane in a solvent, the solvent is allowed to evaporate off and drying is effected at 105° C. The maleic anhydride serves as a coupling agent between the silanized cellulose fibers and the plastic.

### OBJECT OF THE INVENTION

Compared with the known composite materials comprising a thermoplastic and lignocellulosic fibers, it is the object of the present invention to provide a composite material of the generic type having improved properties.

In particular, it is the object of the present invention to provide a composite material comprising a thermoplastic and lignocellulosic material, which composite material has improved mechanical properties, for example a higher notched impact strength, an improved modulus of elasticity and a higher tensile strength and, preferably, lower water absorption.

It is a further object to provide a process for producing the composite material, which can be carried out substantially without an organic solvent.

### GENERAL DESCRIPTION OF THE INVENTION

The invention achieves the abovementioned objects by derivatizing lignocellulosic fibers by treatment with silanes which firstly produce an adhesion-promoting effect between lignocellulosic fibers and thermoplastic and secondly render the lignocellulosic fibers water-repellent.

In the preferred process, an oligomeric condensate of different silanes, referred to below as organopolysiloxane, which serves as an adhesion promoter and as a water repellent, are brought into contact with the lignocellulosic fibers in aqueous solution so that substantially no organic solvents are used.

Furthermore, it is preferable if, after the treatment with the silane mixture, the lignocellulosic fibers are dried and are subjected to heating at about 80-120° C., preferably about 100-105° C. This drying and heating can be carried out in one stage or a plurality of stages, for example as predrying at 40° C. and curing at 120° C.

The content of lignocellulosic fibers in composite materials according to the invention is, for example, from 10 to 90% by weight, it being possible to use wood flour, wood turnings and/or wood chips from hardwoods or softwoods and mixtures thereof as lignocellulosic fibers. In particular, polyolefins, polyethylene, polypropylene, preferably isotactic polypropylene, block copolymers and copolymers of polyethylene units and polypropylene units, PVC, polystyrene, acrylonitrile-butadiene-styrene (ABS) or melamine resin are suitable as plastic, which is preferably thermoplastic. Particularly preferably, the plastic is not derivatized or provided with functional groups, for example not provided with carboxyl groups.

### EXACT DESCRIPTION OF THE INVENTION

According to the invention, lignocellulosic fibers are reacted by a treatment with organopolysiloxanes or copolymers thereof in a water-based mixture. As a result, the adhesion promotion between lignocellulosic fibers and thermoplastic in the composite material is improved. Consequently, both the physicomechanical properties of the composite material are improved and the absorption of liquid and gaseous water is reduced.

The organopolysiloxanes to be used according to the invention are obtainable by mixing water-soluble aminoalkylalkoxysilanes which have the general formula I

R—Si(R¹)_{y}(OR¹*)_{3-y} (I)

with water-insoluble alkyltrialkoxysilanes which have the general formula II

R²—Si(OR¹**)₃ (II)

optionally additionally in combination with water-insoluble dialkyldialkoxysilanes of the general formula III

AA′-Si(OR¹***)₂ (III).

Here, R is an aminofunctional group, aliphatic, branched or straight-chain or aromatic with 2 to 8 carbon atoms, which contains primary, secondary, tertiary, preferably quaternary aliphatic or aromatic amino groups or may have the general formula IV:

[Z_{(f+g+h)}]^{(f+g+h)}-[NH_{2+f}(CH₂)_{b}(NH_{g+1})_{c}(CH₂)_{d}(NHₕ₊₁)ₑ(CH₂)ᵢ]^{(f+g+h)+} (IV)

in which 0≦b≦3; 0≦d≦3; 0≦i≦3; 0≦f≦1; 0≦g≦1; 0≦h≦1; 0≦c≦1; 0≦e≦1 and b+d+i≠0 and also c=0 for b=0, also e=0 for d=0, also e=0 for i=0 and also c=0 for d=i=0. Here, Z is a monovalent inorganic or organic acid radical. R¹, R¹*, R¹** and R¹***, independently of one another, are a methyl or ethyl radical, R² is a linear, cyclic or branched alkyl radical having 1 to 8 carbon atoms, A is a straight-chain or branched alkyl radical having 1 to 3 carbon atoms and A′ is a straight-chain or branched alkyl radical having 1 to 3 carbon atoms and 0≦y≦1. Preferably, the molar ratio of compounds of the formula I to the sum of those of the formulae II and III is from 0 to 2.

In a preferred embodiment, the water-soluble aminoalkylalkoxysilane is 3-aminopropyltriethoxysilane and the water-insoluble alkyltrialkoxysilane is isobutyltrialkoxysilane.

The organopolysiloxane, which consists of water-soluble aminoalkylalkoxysilane and at least one water-insoluble alkyltrialkoxysilane, optionally at least one further water-insoluble dialkyldialkoxysilane, is preferably prepared with acid catalysis. Acid catalysis preferably means that the pH has a value from 1 to 8, more preferably from 3 to 5. The organopolysiloxane can therefore be defined as a condensate of at least one water-soluble aminoalkylalkoxysilane and at least one water-insoluble alkyltrialkoxysilane, optionally at least one further water-insoluble dialkyldialkoxysilane. The organopolysiloxane can therefore also be described as a condensate of the at least one water-soluble aminoalkylalkoxysilane hydrolyzed with acid or base catalysis and of the at least one water-insoluble alkyltrialkoxysilane. The number of silane units in the organopolysiloxane, which as a rule is present in distribution or in a mixture, preferably comprises an average distribution of from 5 to 20, preferably from 10 to 18, particularly preferably 15, siloxane units. In this way, a preferred degree of oligomerization of the organopolysiloxane can be described. The preparation of a preferred organopolysiloxane is described in EP 0 716 128 or EP 0 716 127.

In a particularly preferred embodiment, the organopolysiloxane used is water-based and substantially free of alcohols, it being possible to prepare the organopolysiloxane by mixing the water-soluble aminoalkoxysilane with the water-insoluble dialkylalkoxysilane in water, adjusting the pH to a value of from 1 to 8, preferably from 3 to 5, and removing alcohol, preferably by vacuum distillation prepared. For the acid catalysis or for adjusting the pH, inorganic or organic acids may be used, preferably formic acid or acetic acid. A preferred, water-based organopolysiloxane composition is disclosed in EP 0 716 128 A2 and is available under the name Dynasylan® from Degussa AG, Germany.

It is preferable if the treatment of the lignocellulosic fibers takes place over a relatively long period, for example over two hours, with agitation. It is preferable if the silanization of the lignocellulosic fibers is carried out at from about 40 to 70° C., preferably 40° C., which leads to an increase in the amount of organopolysiloxane introduced into the lignocellulosic material. Furthermore, it is preferable if an aqueous formulation of the organopolysiloxanes according to the invention has a pH of from 3 to 4 during the treatment, for example established by formic acid, and is completely hydrolyzed by relatively long mixing of the aqueous solution for use.

Alternatively, an organopolysiloxane-containing composition, preferably based on water, can be prepared by mixing water-soluble aminoalkylalkoxysilanes of the general formula I

R—Si(R¹)_{y}(OR¹*)_{3-y} (I)

in the molar ratio >0 to not more than 2 with water-insoluble aminoalkoxysilanes of the general formula II

R²—Si(OR¹**)₃ (II)

R being an aminofunctional organic group of the general formula V

[Z_{(f+c+f*)}]^{(f+c+f}*⁾-[A_{d}NH⁻_{(2+f-d)}[(CH₂)ₐNA¹ₑH⁻_{(1-e+f*)}]_{c}(CH₂)_{b}⁻]^{(f+c+f)}*⁺ (V)

in which 0≦a≦6; 0≦b≦1; 0≦c≦1; 0≦d≦2; 0≦e≦1; 0≦f≦1; 0≦f*≦1, A and A¹ are a benzyl or vinylbenzyl radical, N is nitrogen and Z is a monovalent inorganic or organic acid radical, for example selected from the group consisting of Cl⁻, NO₃⁻, HCOO⁻, CH₃COO, R1, R1** and R**,
R¹, R¹* and R¹** being a methyl or ethyl radical and
R² being a linear, cyclic or branched alkyl radical having 1 to 6 carbon atoms or a ureidoalkyl group of the general formula VI

NH₂—CO—NH—(CH₂)_{b}— (VI)

and 0≦y≦1,
subsequently adding water to the mixture,
adjusting the pH to a value of from 1 to 8, and
removing the alcohol present and/or formed in the reaction.

The invention will now be described with reference to the figures, in which

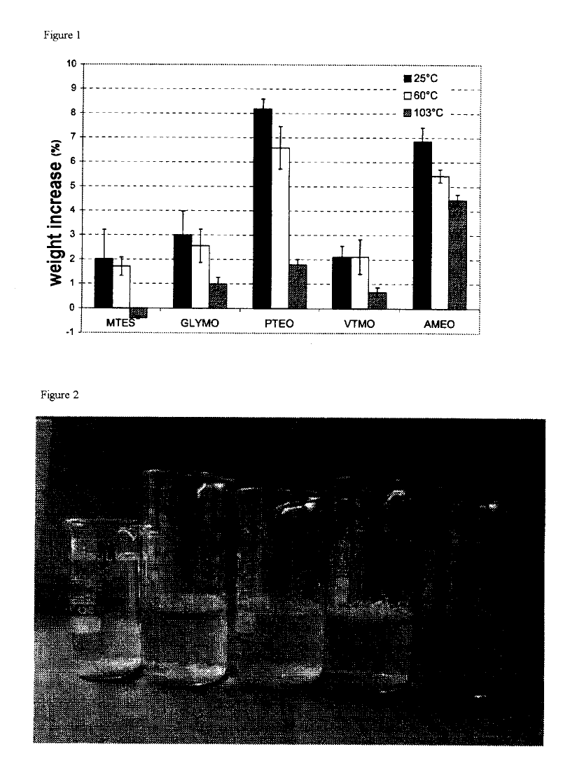

FIG. 1 shows the weight increase of spruce wood turnings after the treatment with various organopolysiloxanes as a function of the drying temperature and

FIG. 2 shows wood turnings treated with various organopolysiloxanes in the float test after 48 hours.

### EXAMPLE 1

### Treatment of Lignocellulosic Fibers with Organopolysiloxanes

As an example of lignocellulosic fibers, spruce wood turnings were suspended and stirred with various silanes in water, for control only in water. Before addition of the spruce wood turnings, the organopolysiloxanes were prepared to a concentration of 3% by weight in water, adjusted to pH 4 by addition of acetic acid and stirred for 30 minutes in order to ensure complete hydrolysis. It was observed that the initially formed emulsion became a clear solution. 40 g of turnings (10.2% moisture) were added to the solution and shaken for 2 hours in a horizontal shaker and then filtered off.

For the organopolysiloxanes, methyltriethoxysilane (Dynasylan® MTES), 3-glycidyloxypropyltrimethoxysilane (Dynasylan® GLYMO), propyltriethoxysilane (Dynasylan® PTEO), vinyltrimethoxysilane (Dynasylan® VTMO) and 3-aminopropyltriethoxysilane (Dynasylan® AMEO) were used. The organopolysiloxanes having the designation Dynasylan® are available from Degussa AG, Marl, Germany.

Aliquots were dried at 25° C., 60° C. and 103° C., respectively for 72 hours. Thereafter, the turnings were conditioned at 20° C. and 25% relative humidity to constant weight and were weighed. The dry weight or the moisture content of each sample was determined by drying at 103° C. and weighing.

The results of the weight increase of spruce wood turnings are shown in FIG. 1, it being clear that, on drying at 20° C. and 65° C., the turnings are not coated with any significant amounts of silane which would stand a thermal treatment of 103° C. for determining the dry weight. This is due to the fact that, at lower temperatures, no condensation, or only little condensation, of the silanes occurred and these were volatilized during the subsequent drying at 103° C. It is therefore preferable if, after the contacting with organopolysiloxanes, the lignocellulosic fibers are treated by heating to a temperature at or above 80° C.

The weight loss of the control turnings, which were treated only in water without organopolysiloxane, was 1.0% (103° C.).

In FIG. 1, it is clear that, with the exception of the MTES, all organopolysiloxanes used led to a weight increase of the spruce wood turnings even on drying at 103° C.

### EXAMPLE 2

### Adhesion Promotion of and Imparting of Water Repellency to Lignocellulosic Fibers

Spruce wood turnings treated according to Example 1 were suspended in water and left to stand for 48 hours. This so-called float test is shown in FIG. 2 and makes it clear that the strongest water repellency was achieved with organopolysiloxane comprising vinyltrimethoxysilane (Dynasylan® VTMO), followed by 3-aminopropyltriethoxysilane (Dynasylan® AMEO).

Spruce wood turnings silanized with organopolysiloxane comprising Dynasylan® VTMO or Dynasylan® AMEO and control turnings treated with water were processed with isotactic polypropylene to give composite materials. A proportion of turnings of 60% by weight with 40% by weight of polypropylene was used.

The composite material comprising silanized spruce wood turnings and polypropylene was produced by preparing a mechanical mixture of the silanized spruce wood turnings with granulated polypropylene (random polypropylene copolymer (randomly distributed copolymer), melt flow index according to ISO 1133 (MFI)=1.8±0.4 g/10 min at 230° C./2.16 kg) in a roll mill and then pressing said mixture. For this purpose, homogeneous mill hides were produced on the roll mill from the mixture of granulated polypropylene and silanized spruce wood turnings at 180° C. and a circumferential speed of 25 rpm over 5 to 10 min, which mill hides were then heated in the press (e.g. platen press “Schwabendan”, type Polystat 400A), initially without pressure for 20 min to about 180° C. and then pressed for 30 s at 10 bar. The cooling to room temperature was effected for 20 min in the press while maintaining the pressure.

The mechanical properties were then determined with reference to the standards ISO 180 (notched impact strength), ISO 527-2 (tensile strength) and ISO 1183-1 (density) and are shown in Table 1 below.

TABLE 1
Mechanical properties of composite materials

| | Treatment of the wood turnings with | | |
|---|---|---|---|
| | organopolysiloxane comprising | | |
| | Dynasylan ® | Dynasylan ® | Control |
| | VTMO | AMEO | (water) |
| Notched impact | 4.37 | 4.78 | 4.07 |
| strength (J) | | | |
| Modulus of elasticity | 3144 | 3316 | 3721 |
| (N/mm²) | | | |
| Tensile strength | 25.6 | 33.8 | 25.8 |
| (N/mm²) | | | |
| Density (g/cm³) | 1.08 | 1.094 | 1.07 |

The results in Table 1 show that the notched impact strength of the composite materials was increased compared with the control material comprising untreated spruce wood turnings, while the modulus of elasticity was lower. The tensile strength remained virtually unchanged for the spruce wood turnings treated with organopolysiloxane comprising Dynasylan® VTMO, whereas it has increased substantially for the composite material of the spruce wood turnings treated with organopolysiloxane comprising Dynasylan® AMEO. The density of the composite materials according to the invention was increased, which, like the increased notched impact strength and the identical or increased tensile strength, indicates a tighter bond between lignocellulosic fibers and plastic.

For determining the storage in water, the composite materials were stored in water for 14 days with reference to EN ISO 62, the weight increase being determined after 1, 3, 7 and 14 days. The percentage weight increases are shown in Table 2 below.

TABLE 2
Weight increase by incorporation of water into
composite materials

| | Treatment of the wood turnings with | | |
|---|---|---|---|
| | organopolysiloxane comprising | | |
| | Dynasylan ® | Dynasylan ® | Control |
| | VTMO | AMEO | (water) |
| Initial weight (g) | 3.5440 | 3.7151 | 3.4980 |
| Weight increase after | 1.43 | 1.67 | 2.17 |
| 1 d (%) | | | |
| Weight increase after | 2.24 | 2.54 | 3.35 |
| 3 d (%) | | | |
| Weight increase after | 3.30 | 3.60 | 5.03 |
| 7 d (%) | | | |
| Weight increase after | 4.50 | 4.53 | 6.93 |
| 14 d (%) | | | |

On the basis of the smaller weight increase in the case of the composite materials according to the invention for the spruce wood turnings treated with organopolysiloxane comprising Dynasylan® VTMO or Dynasylan® AMEO in combination with polypropylene, by way of example, the values of Table 2 show a substantially smaller incorporation of water compared with the composite material comprising water-treated or untreated spruce wood turnings (control).

### EXAMPLE 1

### Composite Material Comprising Polypropylene and Spruce Wood Turnings which are Treated with Dynasylan® HS 2909

Spruce wood turnings were incubated according to Example 1 with an aqueous formulation of organopolysiloxane comprising 3-aminopropyltriethoxysilane and isobutyltriethoxysilane, commercially available under the designation Dynasylan® HS 2909 (Degussa AG, Germany), in concentrations of 3, 4, 5 and 7.5% by weight for 12 hours with shaking. The turnings were then separated off by sieving and were dried at 103° C. for 72 hours.

The spruce wood turnings treated with Dynasylan® HS 2909 were processed with isotactic polypropylene in a ratio of 60% by weight to 40% by weight by mixing with granules and subsequent extrusion to give a composite material according to the invention. The mechanical properties are shown in Table 3 below as a function of the concentration of organopolysiloxane (Dynasylan® HS 2909) used.

TABLE 3
Mechanical properties of the composite
material according to the invention comprising
isotactic polypropylene with spruce wood turnings
treated with Dynasylan ® HS 2909

| | Dynasylan ® | Dynasylan ® | Dynasylan ® | |
|---|---|---|---|---|
| | HS 2909 | HS 2909 | HS 2909 | Control |
| | (3%) | (4.5%) | (7.5%) | (water) |
| Notched | 6.0 | 6.25 | 5.72 | 4.07 |
| impact | | | | |
| strength (J) | | | | |
| Modulus of | 3274 | 3441 | 3449 | 3721 |
| elasticity | | | | |
| (N/mm²) | | | | |
| Tensile | 31.3 | 34.2 | 35.7 | 25.8 |
| strength | | | | |
| (N/mm²) | | | | |
| Density | 1.09 | 1.09 | 1.09 | 1.07 |
| (g/cm³) | | | | |

The values in Table 3 show that at least the notched impact strength and the tensile strength of the composite material were improved by the treatment of the lignocellulosic fibers with an organopolysiloxane according to the invention compared with the control which contained spruce wood turnings treated only with water.

The incorporation of water was determined according to Example 2; the values are summarized in Table 4 below.

TABLE 4
Incorporation of water into composite material
comprising isotactic polypropylene with spruce wood
turnings silanized with Dynasylan ® HS 2909

| | Dynasylan ® | Dynasylan ® | Dynasylan ® | |
|---|---|---|---|---|
| | HS 2909 | HS 2909 | HS 2909 | Control |
| | (3%) | (4.5%) | (7.5%) | (water) |
| Initial weight | 3.5688 | 3.6480 | 3.6231 | 3.4980 |
| (g) | | | | |
| Weight | 1.28 | 1.06 | 0.98 | 2.17 |
| increase | | | | |
| after 1 d (%) | | | | |
| Weight | 1.93 | 1.76 | 1.58 | 3.35 |
| increase | | | | |
| after 3 d (%) | | | | |
| Weight | 2.85 | 2.56 | 2.35 | 5.03 |
| increase | | | | |
| after 7 d (%) | | | | |
| Weight | 3.87 | 3.49 | 3.2 | 6.93 |
| increase | | | | |
| after 14 d | | | | |
| (%) | | | | |

The measured values of Table 4 show that the incorporation of water is substantially reduced by the treatment with an organopolysiloxane according to the invention, the treatment with only a 3% by weight solution being sufficient to reduce the weight increase after 14 days to a value of less than 4%, which corresponds approximately to the water increase by isotactic polypropylene without spruce wood turnings. A higher content of organopolysiloxanes according to the invention, for example obtainable by treatment of the spruce wood turnings with higher concentrations of the aqueous organopolysiloxanes according to the invention, leads to further reduced values for the incorporation of water into the composite material.

1. A composite material which contains lignocellulosic fibers and a thermoplastic, characterized in that the lignocellulosic fibers are treated with an aqueous composition which comprises an organopolysiloxane which is based on at least one water-soluble aminoalkyltrialkoxysilane and at least one water-insoluble alkyltrialkoxysilane.

2. The composite material as claimed in claim 1, characterized in that the organopolysiloxane contains at least one water-insoluble dialkyldialkoxysilane.

3. The composite material as claimed in claim 1, characterized in that
the water-soluble aminoalkoxysilane has the general formula I
R—Si(R¹)_{y}(OR¹*)_{3-y} (I)
and the water-insoluble alkyltrialkoxysilane has the general formula II
R²—Si(OR¹***)₃ (II)
in which R¹, R¹* and R¹** independently are a methyl or ethyl radical, R² is a linear, cyclic or branched alkyl radical having 1 to 8 carbon atoms and y=0 or 1 and in which R is a primary, secondary, tertiary, or quaternary aliphatic or aromatic amino group.

4. The composite material as claimed in claim 3, characterized in that the water-insoluble dialkyldialkoxysilane has the general formula III
AA′-Si(OR¹***)₂ (III)
in which R¹, R¹*, R¹** and R¹*** independently are a methyl or ethyl radical, R² is a linear, cyclic or branched alkyl radical having 1 to 8 carbon atoms, A is a straight-chain or branched alkyl radical having 1 to 3 carbon atoms and A′ is a straight-chain or branched alkyl radical having 1 to 3 carbon atoms.

5. The composite material as claimed in claim 1, characterized in that the water-soluble aminoalkoxysilane has the general formula I
R—Si(R¹)_{y}(OR¹*)_{3-y} (I)
and the water-insoluble alkyltrialkoxysilane has the general formula II
R²—Si(OR¹**)₃ (II)
R being an aminofunctional organic group of the general formula V
[Z_{(f+c+f*)}]^{(f+c+f}*⁾-[A_{d}NH⁻_{(2+f-d)}[(CH₂)ₐNA¹ₑH⁻_{(1-e+f*)}]_{c}(CH₂)_{b}⁻]^{(f+c+f)}*⁺ (V)
in which 0≦a≦6; 0≦b≦1; 0≦c≦1; 0≦d≦2; 0≦e≦1; 0≦f≦1; 0≦f*≦1,
A and A¹ are a benzyl or vinylbenzyl radical, N is nitrogen and Z is a monovalent inorganic or organic acid radical,
R¹, R¹* and R¹** being a methyl or ethyl radical and
R² being a linear, cyclic or branched alkyl radical having 1 to 6 carbon atoms or a ureidoalkyl group of the general formula VI
NH₂—CO—NH—(CH₂)_{b}— (VI)
and y being from 0 to 1.

6. The composite material as claimed in claim 5, characterized in that the organopolysiloxane comprises 3-aminopropyltriethoxysilane as a mixture with isobutyltriethoxysilane.

7. Lignocellulosic fibers for use in a composite material as claimed in claim 1, characterized in that the lignocellulosic fibers have been brought into contact with an organopolysiloxane obtainable by mixing water-soluble aminoalkylalkoxysilanes of the general formula I
R—Si(R¹)_{y}(OR¹*)_{3-y} (I)
with a water-insoluble alkyltrialkoxysilane of the general formula II
R²—Si(OR¹**)₃ (II)
and/or a water-insoluble dialkyldialkoxysilane of the general formula III
AA′-Si(OR¹***)₂ (III)
R¹, R¹*, R¹** and R¹*** independently being a methyl or ethyl radical, R² being a linear, cyclic or branched alkyl radical having 1 to 8 carbon atoms, A being a straight-chain or branched alkyl radical having 1 to 3 carbon atoms and A′ being a straight-chain or branched alkyl radical having 1 to 3 carbon atoms and y=0 or 1, and R being a primary, secondary, tertiary, preferably quaternary aliphatic or aromatic amino groups, and have been heated to a temperature above 80° C.

8. Lignocellulosic fibers for use in a composite material as claimed in claim 1, characterized in that the lignocellulosic fibers have been brought into contact with an organopolysiloxane obtainable by mixing water-soluble aminoalkylalkoxysilanes of the general formula I
R—Si(R¹)_{y}(OR¹*)_{3-y} (I)
with a water-insoluble alkyltrialkoxysilane of the general formula II
R²—Si(OR¹**)₃ (II)
R being an aminofunctional organic group of the general formula V
[Z_{(f+c+f*)}]^{(f+c+f}*⁾-[A_{d}NH⁻_{(2+f-d)}[(CH₂)ₐNA¹ₑH⁻_{(1-e+f*)}]_{c}(CH₂)_{b}⁻]^{(f+c+f)}*⁺ (V)
in which 0≦a≦6; 0≦b≦1; 0≦c≦1; 0≦d≦2; 0≦e≦1; 0≦f≦1; 0≦f*≦1,
A and A¹ are a benzyl or vinylbenzyl radical, N is nitrogen and Z is a monovalent inorganic or organic acid radical,
R¹, R¹* and R¹** being a methyl or ethyl radical and
R² being a linear, cyclic or branched alkyl radical having 1 to 6 carbon atoms or a ureidoalkyl group of the general formula VI
NH₂—CO—NH—(CH₂)_{b}— (VI)
and y is from 0 to 1, and
have been heated to a temperature above 80° C.

9. A process for producing a composite material as claimed in claim 1, characterized by the treatment of lignocellulosic fibers with an organopolysiloxane in aqueous composition obtainable by mixing a water-insoluble aminoalkylalkoxysilane of the general formula I
R—Si(R¹)_{y}(OR¹*)_{3-y} (I)
with a water-insoluble alkyltrialkoxysilane of the general formula II
R²—Si(OR¹**)₃ (II)
and/or a water-insoluble dialkyldialkoxysilane of the general formula III
AA′-Si(OR¹***)₂ (III)
R¹, R¹*, R¹** and R¹*** independently being a methyl or ethyl radical, R² being a linear, cyclic or branched alkyl radical having 1 to 8 carbon atoms, A being a straight-chain or branched alkyl radical having 1 to 3 carbon atoms and A′ being a straight-chain or branched alkyl radical having 1 to 3 carbon atoms and y=0 or 1, and R being a primary, secondary, tertiary, preferably quaternary aliphatic or aromatic amino group,
drying of the lignocellulosic fibers at a temperature above 80° C. and
mixing with a thermoplastic above the melting point of the thermoplastic.

10. A process for producing a composite material as claimed in claim 1, characterized by the treatment of lignocellulosic fibers with an organopolysiloxane in aqueous composition obtainable by mixing a water-insoluble aminoalkylalkoxysilane of the general formula I
R—Si(R¹)_{y}(OR¹*)_{3-y} (I)
with a water-insoluble alkyltrialkoxysilane of the general formula II
R²—Si(OR¹**)₃ (II)
R being an aminofunctional organic group of the general formula V
[Z_{(f+c+f*)}]^{(f+c+f}*⁾-[A_{d}NH⁻_{(2+f-d)}[(CH₂)ₐNA¹ₑH⁻_{(1-e+f*)}]_{c}(CH₂)_{b}⁻]^{(f+c+f)}*⁺ (V)
in which 0≦a≦6; 0≦b≦1; 0≦c≦1; 0≦d≦2; 0≦e≦1; 0≦f≦1; 0≦f*≦1,
A and A¹ are a benzyl or vinylbenzyl radical, N is nitrogen and Z is a monovalent inorganic or organic acid radical,
R¹, R¹* and R¹** being a methyl or ethyl radical and
R² being a linear, cyclic or branched alkyl radical having 1 to 6 carbon atoms or a ureidoalkyl group of the general formula VI
NH₂—CO—NH—(CH₂)_{b}— (VI)
and y is from 0 to 1,
drying of the lignocellulosic fibers at a temperature above 80° C. and
mixing with a thermoplastic above the melting point of the thermoplastic.

11. The method of using an organopolysiloxane in aqueous composition for producing a composite material as claimed in claim 1, obtainable by mixing a water-insoluble aminoalkylalkoxysilane of the general formula I
R—Si(R¹)_{y}(OR¹*)_{3-y} (I)
with a water-insoluble alkyltrialkoxysilane of the general formula II
R²—Si(OR¹**)₃ (II)
and/or a water-insoluble dialkyldialkoxysilane of the general formula III
AA′-Si(OR¹***)₂ (III)
R¹, R¹*, R¹** and R¹*** independently being a methyl or ethyl radical, R² being a linear, cyclic or branched alkyl radical having 1 to 8 carbon atoms, A being a straight-chain or branched alkyl radical having 1 to 3 carbon atoms and A′ being a straight-chain or branched alkyl radical having 1 to 3 carbon atoms and y=0 or 1, and R being a primary, secondary, tertiary, preferably quaternary aliphatic or aromatic amino groups.

12. The method of using of an organopolysiloxane in aqueous composition for producing a composite material as claimed in claim 1 obtainable by mixing a water-insoluble aminoalkylalkoxysilane of the general formula I
R—Si(R¹)_{y}(OR¹*)_{3-y} (I)
with a water-insoluble alkyltrialkoxysilane of the general formula II
R²—Si(OR¹**)₃ (II)
R being an aminofunctional organic group of the general formula V
[Z_{(f+c+f*)}]^{(f+c+f}*⁾-[A_{d}NH⁻_{(2+f-d)}[(CH₂)ₐNA¹ₑH⁻_{(1-e+f*)}]_{c}(CH₂)_{b}⁻]^{(f+c+f)}*⁺ (V)
in which 0≦a≦6; 0≦b≦1; 0≦c≦1; 0≦d≦2; 0≦e≦1; 0≦f≦1; 0≦f*≦1,
A and A¹ are a benzyl or vinylbenzyl radical, N is nitrogen and Z is a monovalent inorganic or organic acid radical,
R¹, R¹* and R¹** being a methyl or ethyl radical and
R² being a linear, cyclic or branched alkyl radical having 1 to 6 carbon atoms or a ureidoalkyl group of the general formula VI
NH₂—CO—NH—(CH₂)_{b}— (VI)
and y is from 0 to 1
